(19) United States
(12) Patent Application Publication
(10) Pub. No.: US 2008/0175874 A1
(43) Pub. Date: Jul. 24, 2008

(54) Applied care compositions comprising functionalized nano-particles

(75) Inventors: Vladimir Gartstein, Mason, OH (US); Rolanda Jeanette Johnson, Hamilton, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/655,295

(22) Filed: Jan. 19, 2007

(51) Int. Cl. A61Q 5/12

(52) U.S. Cl. 424/401; 977/742; 977/788

(57) ABSTRACT

A composition comprising: (a) at least one cationic, functionalized nano-particle; and (b) an applied care composition. Additionally, a composition comprising: (a) at least one anionic, functionalized nano-particle; and (b) an applied care composition.

### FIELD OF THE INVENTION

The present invention relates to applied care compositions comprising at least one functionalized nano-particle. More particularly, the present invention relates to applied care compositions comprising at least one functionalized carbon black nano-particle for use on synthetic, semi-synthetic, and/or natural fibers, specifically keratinous fibers.

### BACKGROUND OF THE INVENTION

Keratinous fibers, specifically human skin and hair, are subjected to a variety of insults by extrinsic and intrinsic factors. Such extrinsic factors may include ultraviolet radiation, environmental pollution, wind, heat, infrared radiation, humidity, harsh surfactants and abrasives. Intrinsic factors, however, may include chronological aging (gray hair) and other biochemical changes from within. As a result, numerous hair care compositions have been commercially-developed to address and counteract various extrinsic and intrinsic insults such as loss of color, split ends, fragility, loss of volume, roughness, hair loss, reduction in hair growth rate, reduction in shine and appearance, gray hair and the like. Most of these compositions focus on depositing a composition atop the hair shaft in order to enhance shine, appearance or modify the color of the hair. As a result, these surface-deposited compositions are prevented from physically penetrating into the hair itself which tends to cause damaging or undesirable hair textures. The most notable disadvantage is the inability for such compositions to provide hair colorants without the use of harsh chemicals. Additionally, such surface-deposit colorants may be easily removed from the hair by mechanical forces or chemical agents such as shampoos, conditioners, or daily maintenance products, i.e., hair sprays, hair gels, and the like. Thus, these compositions not only demonstrate poor wear ability and instability but they also tend to stain unwanted surfaces.

Similar to keratinous fibers, deposition of color onto synthetic and semi-synthetic fibers also pose a difficult challenge. Since many of the synthetic fibers start as liquid prior to becoming filaments, colorants are usually added at the liquid state to assure adequate distribution of the dye. Thus, after the fiber is woven into a fabric or other woven surface, the addition of dye to color or modify the texture becomes more difficult.

Accordingly, a need exists for a personal care composition that provides enhanced means for counteracting extrinsic and intrinsic factors affecting keratinous fibers. Overall, there is a need to provide an applied care composition for coloring, maintaining, and/or treating all synthetic, semi-synthetic, and/or natural fibers without the adverse affects associated with existing compositions.

### SUMMARY OF THE INVENTION

The present invention is directed to a composition comprising: (a) at least one cationic, functionalized nano-particle; and (b) an applied care composition.

The present invention also relates to a composition comprising: (a) at least one anionic, functionalized nano-particle; and (b) an applied care composition.

### DETAILED DESCRIPTION OF THE INVENTION

While the specification concludes with the claims particularly pointing out and distinctly claiming the invention, it is believed that the present invention will be better understood from the following description.

All percentages, parts and ratios are based upon the total weight of the compositions of the present invention, unless otherwise specified. All such weights as they pertain to listed ingredients are based on the active level and, therefore; do not include solvents or by-products that may be included in commercially available materials, unless otherwise specified. The term “weight percent” may be denoted as “wt. %” herein. Except where specific examples of actual measured values are presented, numerical values referred to herein should be considered to be qualified by the word “about”.

All molecular weights as used herein are weight average molecular weights expressed as grams/mole, unless otherwise specified.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

The term “applied care” composition, as used herein, refers to any composition for use in applied fields such as industrial, fabric care, home care, and/or personal care. The term “elemental carbon” includes, but is not limited to, carbon black, diamonds, graphite, and the like.

### Functionalized Nano-Particle

The present invention relates to a composition comprising at least one functionalized nano-particle in combination with an applied care composition. The functionalized nano-particles should possess an ionic charge that is opposite the ionic charge of the surface to which the nano-particle is targeted to bind. Although the composition of the present invention allows for the use of either anionic, functionalized nano-particles or polar, functionalized nano-particles, it is more desirable that the functionalized nano-particles be wholly cationic. The cationic, functionalized nano-particles of the present invention may comprise an elemental carbon nano-particle including, but not limited to, carbon black, diamond, graphite, and mixtures thereof. They may also be amorphous, crystalline, or mixtures thereof. The nano-particle may be included at concentrations of at least about 0.1%, at least about 0.5%, at least about 1%, at least about 2% or at least about 5%, by weight of the composition. To increase the functionality and utilization of the cationic, functionalized nano-particles with certain fibers, the nano-particles of the present invention should have a size in diameter that is from at least about 1 nm, at least about 2 nm, at least about 5 nm, at least about 20 nm, or at least about 100 nm and no more than about 1000 nm, no more than about 500 nm, or no more than about 200 nm. Additionally, the functionalized nano-particles may be elliptical, spherical or tubular in shape. The tubular nano-particles may also be measured by length wherein the length is from at least about 50 nm, at least about 100 nm, or at least about 200 nm but no more than about 1000 nm, no more than about 500 nm, or no more than about 300 nm. The size of the functionalized nano-particles can be determined using measurement methods well-known in the art. For example, the Horiba laser scattering and particle size distribution analyzer (model # LA-930) from the Horiba Company or the Malvern particle size instrument (model Zeta Nano Sizer S with a 633 nm HeNe laser) manufactured by Malvern Instruments Ltd. may be used.

The present invention is useful to improve part of or the entire surface property of particles, particularly, the nano-particles of the present invention so that they may be more dispersible in a solvent, such as water or other carrier vehicle. Additionally, such improvement increases the affinity of the nano-particles to bind to certain fibers. This may be achieved through particle surface modification means such as covalent modification, layer-by-layer (LBL) modification, or modification by adsorption. Such modifications may also be used to improve particle dispersion stability.

Covalent Modification

Covalent Modification involves the use of cationic functional groups being introduced to the surface of the nano-particles. Polymer radicals formed by thermal decomposition can be trapped onto the surface of the nano-particles in order to create the functionalized nano-particles useful for the present invention. Such procedure can be better understood as shown in Example 1.

Cationic functional groups may include, but are not limited to, imines, amines, imides, mixtures thereof. Additionally, other cationic compounds containing functional groups such as alcohols (—OH), aldehydes (HC═O), amides (CN═O), amines (—N), carboxylic acid (COOH), esters (—COO), ethers (—O—), ketones (—C═O), thiols (—SH), and mixtures thereof may be used. For example, the present invention may comprise polymethacrylamidopropyl trimonium chloride, polyquatemium cationic polymers, quaternized cellulose derivatives, polyacrylates comprising amino side group, chitosan, and mixtures thereof.

Layer-by-Layer (LBL) Modification

LBL modification involves the deposition of oppositely charged polymers on the surface of the nano-particles. Such process allows for a versatile and inexpensive fabrication of thin films with nanometer-scale control over the spatial distribution of the ionized species within the film. In order to minimize interference with the size, i.e. diameter of the nano-particles, thin films may be desirable. For example, a film of about 1 nm may increase the diameter of a nano-particle that is about 100 nm by about 2% while a film of about 60 nm may substantially increase the diameter by about 120%. Thus, a single layer fabricated by LBL modification and suitable for the present invention may be from about 10 Å, from about 100 Å, or from about 500 Å but no more than about 5000 Å, no more than about 1000 Å, or no more than about 600 Å. The thickness of a single layer depends on the size and orientation of the polymer deposited on the surface of the particle. If, for example, the surface of the nano-particle was negatively charged, LBL modification may be carried out by introducing the surface into a solution or spray consisting of a positively charged polymer, followed optionally by a water or solvent rinse, then into a solution or spray of a negatively charged polymer. This process may be sequentially repeated until desired film thickness and the respective surface charge is reached for substantive particle deposition. The last layer determines the surface charge. Thus, if the last layer of the nano-particle is a positively charged polymer, the overall surface of the nano-particle will be positive. The LBL process can be better understood as shown in Example 2.

Modification by Adsorption

The dynamics of polymeric polyelectrolyte chains on particle surfaces is an important consideration in complex aqueous formulations. Adsorption kinetics of polymers depend on molecular properties of the polyelectrolyte chain, the surface, and thorough processing conditions. Adsorption results in minimizing system thermodynamic energy and is a result of several forces including Van der Waals “hydrophobic” attraction, hydrogen bonding and ionic interaction. Each adsorbing molecule must diffuse to the surface, attach and finally spread. Adsorption is dictated by the adsorption isotherm which plateaus with the polyelectrolyte concentration used. Several external factors affect the adsorption behavior of polyelectrolytes onto surfaces such as temperature, pH, ionic strength, solubility, flow.

### Applied Care Compositions

Applied care compositions of the present invention may comprise any composition for use in applied fields such as industrial, health care, fabric care, home care, and/or personal care. For example, personal care compositions may include, but are not limited to, hair care, skin care, oral care, beauty care, and the like. As used herein, hair care may include, but is not limited to, shampoos, conditioners, sprays, gels, mousse, wax, colorants, perms and relaxers, and the like. As used herein, skin care may include, but is not limited to, body wash, soaps, lotions, gels, sunscreens, ointments, creams, masks, and the like. As used herein, oral care may include, but is not limited to, toothpastes, tooth gels, whitening systems, mouth wash, sprays, and the like. As used herein, beauty care may include, but is not limited to, cosmetics, face creams, face lotions, and the like.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1

D&C Black #2 (hereinafter “carbon black”), obtained from Global Colorants and Sensient, was covalently modified using two cationic compounds, 2,2-Azobis[2-(2-imidazolin-2yl)propane] (AIP) and (2,2′azobis(2methylpropionamine)dihydrochloride) AMPAD which were obtained from Aldrich Chemical, Inc. in dry powder form. Hydrochloric acid (volumetric standard, 0.1 mol/l solution in water) obtained from Aldrich Chemical, Inc. was used without further purification.

The introduction of cationic groups onto the surface of carbon black nano-particles was achieved by trapping of polymer radicals formed by the thermal decomposition of AIP or AMPAD (FIGS. 1 and 2). The experimental method was carried out as described in Okazaki, M., Tsubokawa, N., J. Dispersion Science and Technology, 21(5), 511-524 (2000) as follows:

Into a 100 ml flask, 0.50 g carbon black nano-particles, 0.50 g AIP or AMPAD, and 20 ml of methanol were mixed and stirred with a magnetic stirrer under nitrogen at 65° C. for 36 h. After the reaction, the mixture was centrifuged at 1.5×10⁴ rpm and the supernatant solution was removed by decantation. The resulting carbon black nano-particles were dispersed in methanol and the dispersion was centrifuged again. The procedure was repeated three times and the carbon black nano-particles were dried in vacuum at 100° C.

The AIP treated carbon black nano-particles were then treated with hydrochloric acid in order to convert the imidazoline groups on the surface to imidazoline hydrochloride groups. The mixture of 0.50 g of the AIP treated carbon black nano-particles and 10 ml of 0.1 mol/l of hydrochloric acid was shaken at room temperature for 30 min. The resulting carbon black nano-particles were centrifuged and the supernatant solution was removed by decantation. The precipitated carbon black nano-particles was dispersed in water and centrifuged. The procedures were repeated three times and the carbon black nano-particle was dried in vacuum at 100° C.

The surface of the modified carbon black nano-particles was analyzed by x-ray photoelectron spectroscopy (XPS). Table 2 depicts XPS data for Carbon Raw Material: Results in atomic % (with std. dev. in parentheses). The XPS data indicated the presence of chlorine groups and increased nitrogen groups on the surface of the carbon black nano-particles.

TABLE 1
XPS data for Carbon Raw Material: Results in atomic % (with std.
dev. in parentheses)

| | | | | | | Residual |
|---|---|---|---|---|---|---|
| Samples | C | N | O | S | Cl | elements |
| Carbon black | 93.02 | 0.49 | 6.06 | 0.22 | — | 0.21 |
| control 1 | (0.27) | (0.10) | (0.24) | (0.02) | | |
| AMPAD | 90.80 | 1.99 | 6.71 | 0.09 | 0.4 | 0.01 |
| Modified | (0.81) | (0.21) | (1.15) | (0.04) | (0.13) | |
| carbon | | | | | | |
| black 1 | | | | | | |
| Carbon black | 92.41 | 0.95 | 6.53 | 0.11 | — | 0.0 |
| control 2 | (0.25) | (0.08) | (0.26) | (0.03) | | |
| AMPAD | 92.58 | 1.49 | 5.66 | 0.12 | 0.15 | 0.0 |
| Modified | (0.12) | (0.12) | (0.24) | (0.01) | (0.02) | |
| carbon | | | | | | |
| black 2 | | | | | | |

The modified carbon black nano-particles (1%) were then added to a hair care chassis (50 ml) and stirred with a magnetic stir bar for (5-24 hours).

### Example 2

The following is an example of using LBL on carbon black nano-particles to functionalize the carbon black nano-particles and render the surface cationic. Three layers have been exemplified as follows:

Layer 1

To obtain the first layer of adsorbed polyethyleneimine (PEI, positively charged polymer) on the surface of the carbon black nano-particles, carbon black nano-particles (1%) were added to 100 ml of water in a 150 ml round bottom flask. To this mixture, PEI (1%) was added and stirred for 15 minutes. The mixture was then removed from stirring and centrifuged until a clear separation was obtained between particles and supernatant. The supernatant was then decanted and 100 ml of water was then added to the precipitated particles. The resulting mixture was then sonicated for 5 minutes. Centrifugation, washing and sonication of the carbon black mixture were repeated three times respectively to remove any excess PEI.

Layer 2

To obtain the second layer anionic charge on the surface of the carbon black nano-particles, (PSS) polystyrene sulfonate (1%) was added following sonication to the 1% carbon black nano-particles and 100 ml of water. The solution was stirred for 15 minutes. The mixture was then removed from stirring and centrifuged until a clear separation was obtained between particles and supernatant. The supernatant was then decanted and 100 ml of water was then added to the precipitated particles. The resulting mixture was then sonicated for 5 minutes. Centrifugation, washing and sonication of the carbon black mixture were repeated three times respectively to remove any excess PSS.

Layer 3

To obtain the third layer cationic charge on the surface of the carbon black nano-particles, PEI (1%) was added following sonication to the 1% carbon black and 100 ml of water. The solution was stirred for 15 minutes. The mixture was then removed from stirring and centrifuged until a clear separation was obtained between particles and supernatant. The supernatant was then decanted and 100 ml of water was then added to the precipitated particles. The resulting mixture was then sonicated for 5 minutes. Centrifugation, washing and sonication of the carbon black mixture were repeated three times respectively to remove any excess PEI. The modified carbon black nano-particles were then formulated into a conditioner chassis for treatment on hair.

### Example 3

The following exemplifies the absorption of a cationic compound on the surface of carbon black nano-particles:

Following the addition of 5 ml of 1M NaCl to a 150 ml beaker, 19.8 ml of a conditioner chassis and 19.8 ml of polyethelyeneimine (in excess) was added and allowed to stir at room temperature using a magnetic stir bar. The mixture was allowed to stir until a homogeneous mixture was observed. To the mixture was added 2.077 g of carbon black (D&C Black #2). The mixture was allowed to stir for 24 hours to ensure maximum adsorption of polyethelyeneimine (PEI) on the surface of the carbon black nano-particles. Following the 24 hour reaction time, the final formulation was treated on hair.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the term in a document incorporated herein by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composition comprising:
a. at least one solid nano-particle;
b. at least one cationic functionalized composition deposited on a surface of said nano-particle; and
c. an applied care composition attached to said nano-particle by said functionalized composition.

2. The composition of claim 1, wherein said nano-particle comprises an elemental carbon nano-particle.

3. The composition of claim 2, wherein said elemental carbon nano-particle is selected from the group consisting of carbon black nano-particles, diamond nano-particles, and graphite nano-particles.

4. The composition of claim 1 wherein said nano-particle is from about 1 nm to about 1000 nm in size.

5. The composition of claim 1 wherein said applied care composition is a personal care composition.

6. A composition comprising:
a. at least one solid nano-particle;
b. at least one anionic functionalized composition deposited on a surface of said nano-particle; and,
c. an applied care composition attached to said nano-particle by said functionalized composition.
